(19) United States
(12) Patent Application Publication
(10) Pub. No.: US 2024/0338823 A1
(43) Pub. Date: Oct. 10, 2024

(54) DETECTING OCULAR COMORBIDITIES WHEN SCREENING FOR DIABETIC RETINOPATHY (DR) USING 7-FIELD COLOR FUNDUS PHOTOS

(71) Applicants: Genentech, Inc., South San Francisco, CA (US); Hoffmann-La Roche Inc., Little Falls, NJ (US)

(72) Inventors: Fethallah BENMANSOUR, South San Francisco, CA (US); Jelena NOVOSEL, South San Francisco, CA (US); Jian DAI, Fremont, CA (US); Daniela Ferrara CAVALCANTI, Marlborough, MA (US)

(21) Appl. No.: 18/744,197

(22) Filed: Jun. 14, 2024

Related U.S. Application Data
(63) Continuation of application No. PCT/US2022/081956, filed on Dec. 19, 2022.
(60) Provisional application No. 63/291,123, filed on Dec. 17, 2021.
(60) Provisional application No. 63/330,021, filed on Apr. 12, 2022.

(51) Int. Cl. G06T 7/00

(52) U.S. Cl. CPC G06T 7/0012; G06T 2207/20081; G06T 2207/30041

(57) ABSTRACT

A method and system for detecting a presence of comorbid ocular conditions. Input data that includes imaging data for an eye of a subject is received. A score that indicates whether a presence of a plurality of comorbid ocular conditions is detected is generated in the eye of the subject using a deep learning model and the input data. A comorbidity output is generated based on the score. The comorbidity score may be a classification indicating whether the presence of the plurality of comorbid ocular conditions is detected.

### CROSS-REFERENCE TO RELATED APPLICATIONS

This application is a continuation of International Application No. PCT/US2022/081956, filed on Dec. 19, 2022, and entitled “Detecting Ocular Comorbidities When Screening For Diabetic Retinopathy (DR) Using 7-Field Color Fundus Photos,” which claims priority to U.S. Provisional Patent Application No. 63/330,021, filed on Apr. 12, 2022 and entitled “Detecting Ocular Comorbidities When Screening for Diabetic Retinopathy (DR) Using 7-Field Color Fundus Photos,” and to U.S. Provisional Patent Application No. 63/291,123, filed on Dec. 17, 2021 and entitled “Detecting Ocular Comorbidities When Screening for Diabetic Retinopathy (DR) Using 7-Field Color Fundus Photos,” each of which is incorporated herein by reference in its entirety.

### FIELD

This description is generally directed towards detecting ocular comorbidities of diabetic retinopathy. More specifically, this description provides methods and systems for detecting ocular comorbidities when screening for diabetic retinopathy using machine learning.

### BACKGROUND

Diabetic retinopathy (DR) is a common microvascular complication in subjects with diabetes mellitus. DR occurs when high blood sugar levels cause damage to blood vessels in the retina. The two stages of DR include the earlier stage, non-proliferative diabetic retinopathy (NPDR), and the more advanced stage, proliferative diabetic retinopathy (PDR). With NPDR, tiny blood vessels may leak and cause the retina and/or macula to swell. In some cases, macular ischemia may occur, tiny exudates may form in the retina, or both. With PDR, new, fragile blood vessels may grow in a manner that can leak blood into the vitreous, damage the optic nerve, or both. Untreated, PDR can lead to severe vision loss and even blindness.

In certain cases, it may be desirable to screen for subjects that have at least a selected stage of DR (e.g., mild DR, more than mild DR, moderate DR, severe DR, etc.). Further, in certain cases, it may be desirable to identify those subjects that have one or more ocular comorbidities in addition to DR. Such ocular comorbidities may include ocular conditions such as, but not limited to, glaucoma, drusen, ocular neuropathy, age-related macular degeneration (AMD), neovascular age-related macular degeneration (nAMD), geographic atrophy (GA), and macular edema (ME). Some currently available methodologies for performing such screenings may be less accurate and more time-consuming than desired. Thus, it may be desirable to have one or more methods, systems, or both that recognize and take into account one or more of these issues.

### SUMMARY

In one or more embodiments, a method may be provided for detecting comorbid ocular conditions. Input data that includes imaging data for an eye of a subject is received. A score is generated that indicates whether a presence of a plurality of comorbid ocular conditions is detected in the eye of the subject using a deep learning model and the input data. A comorbidity output is generated based on the score. The comorbidity score may be, for example, without limitation, a classification indicating whether the presence of the plurality of comorbid ocular conditions is detected.

In one or more embodiments, a method may be provided for detecting comorbid ocular conditions. Input data is received that includes imaging data for an eye of a subject. A metric is generated, via a deep learning model, for the eye of the subject using the input data. The metric indicates a likelihood of a presence of diabetic retinopathy in the eye of the subject. A confidence score is generated for the metric in which the confidence score indicates a positive detection of a presence of a plurality of comorbid ocular conditions when the confidence score is below a selected threshold. An output is generated based on the confidence score.

In one or more embodiments, a method may be provided for detecting comorbid ocular conditions. Input data is received that includes imaging data for an eye of a subject. A metric is generated, via a deep learning model, for the eye of the subject using the input data over a plurality of runs to form a plurality of metrics. The metric for each of the plurality of runs indicates a likelihood of a presence of diabetic retinopathy in the eye of the subject. A statistical metric is generated for the plurality of metrics in which the statistical metric indicates a positive detection of a presence of a plurality of comorbid ocular conditions when the statistical metric is above a selected threshold. An output is generated based on the statistical metric.

In one or more embodiments, a system for detecting comorbid ocular conditions comprises a memory containing machine readable medium comprising machine executable code and a processor coupled to the memory. The processor is configured to execute the machine executable code to cause the processor to: receive input data that includes imaging data for an eye of a subject; generate a score that indicates whether a presence of a plurality of comorbid ocular conditions is detected in the eye of the subject using a deep learning model and the input data; and generate a comorbidity output based on the score.

### BRIEF DESCRIPTION OF THE DRAWINGS

The present disclosure is described in conjunction with the appended figures:

FIG. 1 is a block diagram of an detection system in accordance with one or more embodiments.

FIG. 2 is a block diagram of the data analyzer 108 from FIG. 1 in accordance with one or more embodiments.

FIG. 3 is a schematic diagram of an exemplary deep learning model 300 in accordance with one or more embodiments.

FIG. 4 is a flowchart of a process for detecting the presence of comorbid ocular conditions in accordance with one or more embodiments.

FIG. 5 is a flowchart of a process for training a binary classification model to generate a score that indicates whether comorbid ocular conditions are detected in accordance with one or more embodiments.

FIG. 6 is a flowchart of a process for generating a confidence score that indicates whether comorbid ocular conditions are detected in accordance with one or more embodiments.

FIG. 7 is a flowchart of a process for generating a statistical metric that indicates whether comorbid ocular conditions are detected in accordance with one or more embodiments.

FIG. 8 is a block diagram illustrating an example of a computer system in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### I. Overview

A subject having an eye with comorbid ocular conditions has at least two ocular conditions that exist simultaneously in that eye. These ocular conditions may include ocular diseases, ocular disorders, abnormal ocular characteristics (or features), and/or other types of conditions associated with the eye that impact vision health. In certain cases, patients with diabetic retinopathy (DR) may be afflicted with comorbid ocular conditions such as, but not limited to, glaucoma, drusen, ocular neuropathy, age-related macular degeneration (AMD), neovascular age-related macular degeneration (nAMD), geographic atrophy (GA), macular edema (ME), and/or other such ocular conditions. Being able to easily, accurately, efficiently, and/or quickly detect which subjects and which eye(s) of the subjects have comorbid ocular conditions may be helpful in both clinical trial and healthcare settings.

In the context of clinical trials, detection of comorbid ocular conditions may be used as an inclusion or exclusion factor in the screening of subjects for a clinical trial. For example, for a clinical trial that is testing out a treatment regimen for diabetic retinopathy, it may be desirable to exclude subjects or the specific eyes of subjects having comorbid ocular conditions so as not to bias the results of the clinical trial. As another example, it may be desirable in some cases to include only those subjects or the specific eyes of subjects having comorbid ocular conditions in a clinical trial that is targeting treatment of comorbid ocular conditions. In some cases, it may be important to identify the presence of comorbid ocular conditions so as to discontinue participation of the eye of a subject or the subject from a clinical trial.

In the context of healthcare, early detection and diagnosis of comorbid ocular conditions is important because comorbid ocular conditions, such as those described above, may be vision-threatening, especially in combination with diabetic retinopathy. Further, early detection and diagnosis of comorbid ocular conditions may enable early treatment to improve or maintain vision health and may help identify the proper treatment regimen for a subject, or both. Still further, detection of comorbid ocular conditions may be important to determining whether adjustments should be made to a subject's treatment regimen (e.g., to the treatment itself, to the dosage, to the frequency of injections, etc.). Accordingly, detection of comorbid ocular conditions may be used in a variety of different ways to improve the overall vision health of subjects and, in particular, those subjects with diabetic retinopathy.

Currently, screening or prescreening of a subject for comorbid ocular conditions (e.g., ocular conditions relating to and/or coexisting with DR) may include generating imaging data (e.g., color fundus images or color fundus composite images) for a subject and sending the imaging data to expert human graders who have the requisite knowledge and experience to determine whether comorbid ocular conditions are present. Repeating this process for hundreds, thousands, or tens of thousands of subjects that need to undergo screening can be expensive, grader-dependent, and time-consuming. In some cases, this type of manual detection may form a “bottleneck” that can hinder a clinical trial or study. Further, in certain cases, this type of manual detection may not be as accurate as desired due to human error.

Accordingly, it may be desirable to have an automated methodology for screening for comorbid ocular conditions, including ocular conditions relating to and/or coexisting with DR, that improves the accuracy, speed, efficiency, and ease of detection associated with such screening. Further, it may be desirable to reduce the time and costs associated with screening, provide a grader-independent or near grader-independent process, mitigate one or more of the other issues described above, or a combination thereof.

Recognizing and taking into account the importance and utility of a methodology and system that can provide the improvements described above, the methods and systems described herein provide machine learning-based techniques for detecting the presence of comorbid ocular conditions in the eye of a subject. In one or more embodiments, the methods and systems described herein use deep learning and out-of-distribution techniques to detect the presence of comorbid ocular conditions. These techniques may also be used to identify the individual ocular conditions or categories of ocular conditions that have been detected.

The embodiments described herein recognize that, in some cases, it may be desirable to have a first trained deep learning model for detecting diabetic retinopathy (e.g., DR within a selected range of severity) and a second trained deep learning model for detecting comorbid ocular conditions. Thus, the embodiments described herein provide methods and systems for using two deep learning models to independently detect diabetic retinopathy and comorbid ocular conditions. These two deep learning models may be trained to use eye imaging data such as, for example, without limitation, color fundus imaging data (e.g., 7-field color fundus imaging data, 4-widefield color fundus imaging data, etc.) to perform these detections. In other embodiments, the deep learning models may be trained to use other types of imaging data in addition to or in place of color fundus imaging data. These other types of imaging data may include, for example, but are not limited to, optical coherence tomography (OCT) imaging data, fundus autofluorescence (FAF) imaging data, fluorescein angiography (FA) imaging data, infrared (IR) imaging data, near-infrared (nIR) imaging data, or a combination thereof. An exemplary implementation of how two deep learning models may be used for both DR detection described in greater detail in Section II.B and Section II.C.1.

Additionally, the embodiments described herein recognize that, in some cases, it may be desirable to use one trained deep learning model to detect both diabetic retinopathy (e.g., DR within a selected range of severity) and comorbid ocular conditions. Thus, the embodiments described herein provide methods and systems for using a deep learning model that is trained to generate a metric that indicates a presence of diabetic retinopathy (e.g., DR within a selected range of severity). Information obtained from the deep learning model being used in inference mode (which may also be referred to as a prediction mode or non-training mode) may be used to make the detection of comorbid ocular conditions. For example, an out-of-distribution (OOD) detector may be used to determine whether the presence of comorbid ocular conditions is detected. The OOD detector considers imaging data in which the presence of comorbid ocular conditions has been detected as out-of-distribution (OOD).

In some embodiments, the OOD detector may be implemented using an uncertainty estimation algorithm that determines an uncertainty associated with the metric generated by the deep learning model for a given model input (e.g., imaging data for the eye of a subject). A greater level of uncertainty may be considered indicative of the presence of comorbid ocular conditions. A lower level of uncertainty may be considered indicative of an absence of comorbid ocular conditions. This uncertainty estimation algorithm may include, for example, without limitation, a Monte Carlo Dropout algorithm. An exemplary implementation for this algorithm is described in greater detail in Section II.C.2.

In other embodiments, the OOD detector may be implemented using a confidence algorithm that computes a confidence score for the metric generated by the deep learning model for a given model input (e.g., imaging data for the eye of a subject). A higher confidence score may be considered indicative of the presence of comorbid ocular conditions. A lower confidence score may be considered indicative of an absence of comorbid ocular conditions. The confidence score may be computed using, for example, without limitation, an algorithm that involves class-conditional Gaussian distributions for the feature map of at least one intermediate layer of the deep learning model. An exemplary implementation for this algorithm is described in greater detail in Section II.C.3.

The embodiments described herein enable rapid detection of comorbid ocular conditions to improve comorbidity screening, enabling a greater number of subjects to be reliably screened in a shorter amount of time. In some embodiments, improved comorbidity screening may allow healthcare providers to provide improved treatment recommendations or to recommend follow-on risk analysis or monitoring of a subject identified as having comorbid ocular conditions. In some embodiments, the systems and methods described herein may be used to train expert human graders to more accurately and efficiently identify comorbid ocular conditions or to flag eyes of subjects suspected of having comorbid ocular conditions for further analysis by expert human graders.

### II. Exemplary System for Detecting Ocular Comorbidities Associated with DR

### II.A. Overview of Detection System

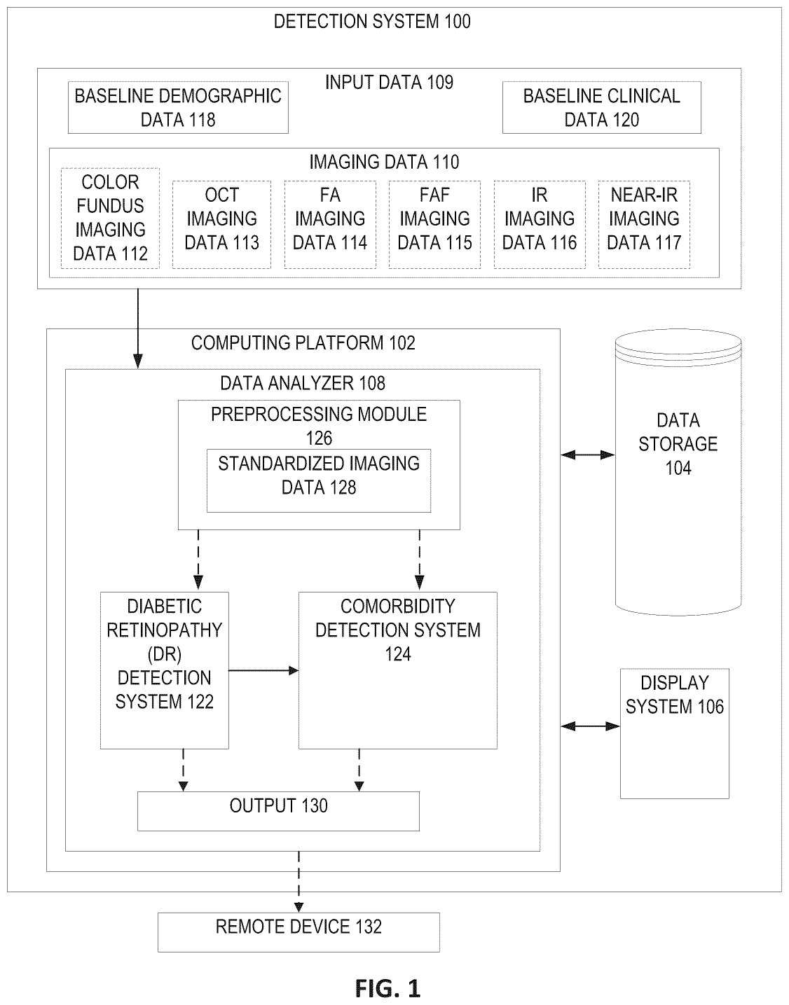

FIG. 1 is a block diagram of a detection system 100 in accordance with one or more embodiments. Detection system 100 may be used to screen for diabetic retinopathy (DR), evaluate DR severity, detect the presence of comorbid ocular conditions, identify any comorbid ocular conditions that may be present, or a combination thereof. Ocular conditions may include ocular diseases, ocular disorders, abnormal ocular characteristics (or features), and/or other types of conditions associated with the eye that impact vision health. Comorbid ocular conditions may include, for example, but are not limited to DR, glaucoma, drusen, ocular neuropathy, age-related macular degeneration (AMD), neovascular age-related macular degeneration (nAMD), geographic atrophy (GA), and macular edema (ME).

Detection system 100 includes computing platform 102, data storage 104, and display system 106. Computing platform 102 may take various forms. In one or more embodiments, computing platform 102 includes a single computer (or computer system) or multiple computers in communication with each other. In other examples, computing platform 102 takes the form of a cloud computing platform.

Data storage 104 and display system 106 are each in communication with computing platform 102. In some examples, data storage 104, display system 106, or both may be considered part of or otherwise integrated with computing platform 102. Thus, in some examples, computing platform 102, data storage 104, and display system 106 may be separate components in communication with each other, but in other examples, some combination of these components may be integrated together.

Detection system 100 includes data analyzer 108, which may be implemented using hardware, software, firmware, or a combination thereof. In one or more embodiments, data analyzer 108 is implemented in computing platform 102.

Data analyzer 108 receives input data 109 for processing. Input data 109 includes imaging data 110. Imaging data 110 includes eye imaging data, which may include any type of imaging data (e.g., images, stereoscopic images, etc.) that captures the eye (e.g., at least the retina) of a subject. For example, imaging data 110 may include color fundus (CF) imaging data 112, optical coherence tomography (OCT) imaging data 113, fluorescein angiography (FA) imaging data 114, fundus autofluorescence (FAF) imaging data 115, infrared (IR) imaging data 116, near-infrared (nIR) imaging data 117, or a combination thereof.

Color fundus imaging data 112 may include, for example, one or more fields of view (or fields) of color fundus images generated using a color fundus imaging technique (also referred to as color fundus photography). In one or more embodiments, color fundus imaging data 112 includes seven-field (7-field or 7F) color fundus imaging data. In some embodiments, each field of view comprises a different color fundus image. In other embodiments, color fundus imaging data 112 includes four-widefield (4W) color fundus imaging data. In some embodiments, the various fields may be integrated or montaged to form a color fundus composite image of the eye.

In one or more embodiments, input data 109 optionally includes baseline demographic data 118 associated with the subject, baseline clinical data 120 associated with the subject, or both. Baseline demographic data 118 may include, for example, without limitation, at least one of an age, sex, height, weight, race, ethnicity, or other type of demographic data associated with the subject. Baseline clinical data 120 may include, for example, without limitation, a diabetic status of the subject, such as a diabetes type (e.g., type 1 diabetes or type 2 diabetes) or diabetes duration.

Data analyzer 108 processes input data 109 using diabetic retinopathy (DR) detection system 122 to detect DR. In one or more embodiments, DR detection system 122 may be used to detect DR having a selected level of severity or within a selected range of severity. For example, DR detection system 122 may be used to detect DR having a severity score (e.g., a DRSS score) that falls within a selected range, is above a minimum threshold, or is below a maximum threshold. Examples of implementing DR detection system 122 are described in greater detail below in Section II.B.

Data analyzer 108 may use comorbidity detection system 124 to detect the presence of comorbid ocular conditions in the eye of the subject. More particularly, comorbidity detection system 124 may be used to detect whether the eye of the subject is suffering from or otherwise afflicted with multiple (i.e., at least two) ocular conditions at the same time. Examples of implementing comorbidity detection system 124 are described in greater detail below in Section II.C.

In some embodiments, data analyzer 108 may send input data 109 directly to DR detection system 122, directly to comorbidity detection system 124, or both for processing. In other embodiments, data analyzer 108 sends input data 109 or at least a portion of input data 109 into preprocessing module 126 for preprocessing prior to being inputted into DR detection system 122, comorbidity detection system 124, or both. Any number of preprocessing operations may be performed by preprocessing module 126.

In one or more embodiments, preprocessing module 126 includes an image standardization system for performing at least one image standardization procedure on the imaging data 110 to generate standardized imaging data 128. A standardization procedure may include at least one of a field detection procedure, a central cropping procedure, a foreground extraction procedure, a region extraction procedure, a central region extraction procedure, an adaptive histogram equalization (AHE) procedure, a contrast limited AHE (CLAHE) procedure, a centering and/or orientation adjustment procedure, or another type of standardization or normalization procedures. In some cases, preprocessing module 126 may perform at least 1, 2, 3, 4, 5, 6, or 7 or at most any 7, 6, 5, 4, 3, 2, or 1 of the aforementioned procedures.

A field detection procedure may include any procedure used to detect a field of view within an image (e.g., color fundus image) from which features are to be extracted. A central cropping procedure may include any procedure used to crop a central region of the image from the remainder of the image. A foreground extraction procedure may include any procedure used to extract a foreground region of the image from the remainder of the image. A region extraction procedure may include any procedure used to extract any selected or desired region of the image from the remainder of the image. A central region extraction procedure may include any procedure used to extract a central region of the color fundus image from the remainder of the color fundus image. An AHE procedure may be used to improve the contrast in an image. A CLAHE procedure may be used to limit contrast amplification in an AHE procedure to reduce noise amplification. A centering and/or orientation adjustment procedure may include any procedure used to center an image (e.g., center the portion of the image of interest), any procedure used to reorient or otherwise rotate the image, or both.

Data analyzer 108 may generate output 130 based on the output of DR detection system 122 (which indicates whether DR has been detected), the output of comorbidity detection system 124 (which indicates whether comorbid ocular conditions have been detected), or both. The These outputs are described in greater detail in Section II.B and Section IIC. Output 130 may take the form of a report, one or more notifications, one or more alerts, one or more emails, or a combination thereof.

Output 130 may include the actual outputs of DR detection system 122 and/or comorbidity detection system 124. In some cases, data analyzer 108 may use these outputs to make one or more clinical trial recommendations, one or more treatment recommendations, one or more healthcare recommendations, or a combination thereof. For example, in some cases, output 130 may include a recommendation on whether to include or exclude the subject for a clinical trial. As another example, output 130 may include a recommendation on whether to adjust a treatment for the subject. As yet another example, when output 130 indicates that comorbid ocular conditions have been detected, output 130 may include a recommendation for further testing to identify the types of comorbid ocular conditions present. In this manner, output 130 may take a number of different forms.

In one or more embodiments, at least a portion of output 130 or a graphical representation of at least a portion of output 130 is displayed on display system 106. This display may be for one or more medical professionals or medical entities (e.g., laboratories, clinics, research centers, hospitals, etc.). In some embodiments, at least a portion of output 130 or a graphical representation of at least a portion of output 130 is sent to remote device 132 (e.g., a mobile device, a laptop, a server, a cloud, etc.).

### II.B. DR Detection System

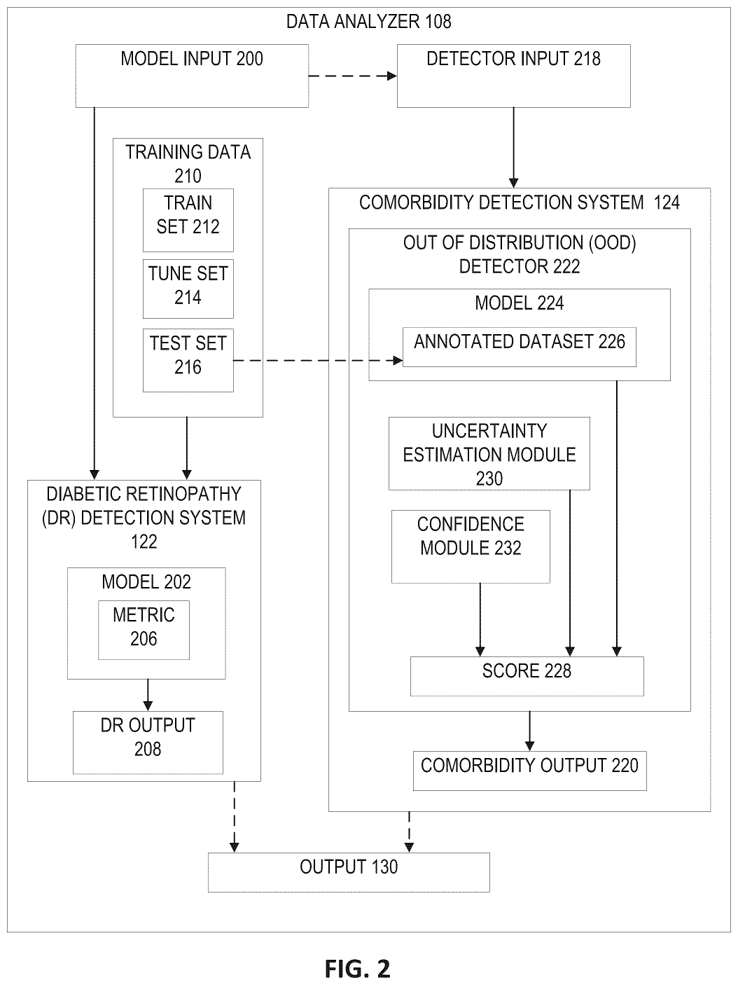

FIG. 2 is a block diagram of data analyzer 108 from FIG. 1 in accordance with one or more embodiments. Data analyzer 108 is described with continuing reference to the elements in FIG. 1 As described in Section II.A., data analyzer 108 includes DR detection system 122. In one or more embodiments, data analyzer 108 includes preprocessing module 126.

DR detection system 122 may receive as model input 200, at least a portion of input data 109, standardized imaging data 128, or both. For example, model input 200 may include imaging data 110. In other examples, model input 200 includes standardized imaging data 128 generated by preprocessing module 126. In yet other examples, model input 200 includes standardized imaging data 128 as well as baseline demographic data 118, baseline clinical data 120, or both. In this manner, model input 200 may be comprised of different combinations of the various types of input data 109 in FIG. 1 and/or standardized imaging data 128.

DR detection system 122 processes model input 200 using model 202. Model 202 includes a deep learning model. The deep learning model may be comprised of one or more neural networks. In one or more embodiments, the deep learning model includes a convolutional neural network (CNN) system that includes one or more neural networks. At least one of these one or more neural networks may itself be a convolutional neural network. In one or more embodiments, model 202 includes a ResNet-50 model with transfer learning. The deep learning model may be implemented using, for example, a binary classification model. Further, model 202 may include any number of equations, formulas, algorithms, other types of models, or combination thereof in addition to the deep learning model.

Model 202 processes model input 200 to generate metric 206 for the eye of the subject. Metric 206 indicates whether DR has been detected. In one or more embodiments, metric 206 indicates whether a presence of DR of a selected severity or within a selected range of severity has been detected.

For example, metric 206 may be a probability value or a value indicating a likelihood that the eye of the subject has DR with a severity score that falls within a selected range, above a minimum threshold, below a maximum threshold, or a combination thereof. Metric 206 may be a value between and/or including 0 and 1. In other embodiments, metric 206 is a category or classifier for the probability or likelihood (e.g., a category selected from a low probability or likelihood and a high probability or likelihood, etc.).

In one or more embodiments, metric 206 is a binary indication of whether the probability or likelihood is above a selected minimum threshold. In some embodiments, the minimum threshold is at least about 0.4, 0.5, 0.6, 0.7, 0.8, 0.9, or some other threshold between 0.4 and 0.95. In one or more embodiments, metric 206 is a binary indication of whether the probability or likelihood is below a selected maximum threshold. In some embodiments, the maximum threshold is at most about 0.6, 0.5, 0.4, 0.3, 0.2, 0.1, or some other threshold between 0.05 and 0.7. In one or more embodiments, metric 206 is a binary indication of whether the probability or likelihood is between a selected range that is defined by a first value selected from any of the preceding values described for the minimum threshold and a second value selected from any of the preceding values described for the maximum threshold.

DR detection system 122 outputs diabetic retinopathy (DR) output 208. DR output 208 may be metric 206 or may be an output generated based on metric 206. As one example, DR output 208 may take the form of a binary output having either a first value (e.g., numerical or text) or a second value (e.g., numerical or text). The first value indicates a positive detection of DR and the second value indicates a negative detection of DR.

A detection of DR may be based on whether the likelihood that DR is present meets one or more criteria (e.g., is above a threshold, is DR of a selected severity or severity range, etc.). Thus, a positive detection of DR means that the likelihood that DR is present meets the one or more selected criteria, while a negative detection of DR means that the one or more criteria are not met.

For example, a positive detection may be made when metric 206 is above a selected threshold, indicating an above-threshold likelihood that the eye of the subject has DR with a severity score that falls within a selected range, is above a minimum threshold, or is below a maximum threshold. The severity score may be, for example, based on the Diabetic Retinopathy Severity Scale (DRSS) developed by the Early Treatment Diabetic Retinopathy Study (ETDRS). The DRSS is largely considered the gold standard, especially in the research context, for classifying the severity of DR. A DRSS score of 35 indicates mild DR, a DRSS score of 43 indicates moderate DR, a DRSS score of 47 indicates moderately severe DR, and a DRSS score of 53 indicates severe DR, which is the precursor to proliferative DR.

The selected range of interest for the DR severity score may be, for example, but is not limited to, a mild to moderate range, a mild to moderately severe range, a mild to severe range, a moderate to moderately severe range, a moderately severe to severe range, a moderate to severe range, a more than mild range, a more than moderate range, a more than moderately severe range, or a more than severe range. In one or more embodiments, these ranges correspond to a portion of the DRSS between and including 35 and 43, between and including 35 and 47, between and including 35 and 53, between and including 43 and 47, between and including 47 and 53, between and including 43 and 53, at least 35, at least 43, at least 47, or at least 53, respectively.

Thus, DR may be classified according to severity. For example, DR severity classifications may include one or more of a mild to moderate DR (corresponding to a DRSS between and including 35 and 43), a mild to moderately severe DR (corresponding to a DRSS between and including 35 and 47), a mild to severe DR (corresponding to a DRSS between and including 35 and 53), a moderate to moderately severe DR (corresponding to a DRSS between and including 43 and 47), a moderate to severe DR (corresponding to a DRSS between and including 43 and 53), a moderately severe to severe DR (corresponding to a DRSS between and including 47 and 53), a more than mild DR (corresponding to a DRSS of at least 35), a more than moderate DR (corresponding to a DRSS of at least 43), a more than moderately severe DR (corresponding to a DRSS of at least 47), and a more than severe DR (corresponding to a DRSS of at least 53).

In one or more embodiments, DR output 208 indicates either a positive detection or a negative detection. In one or more examples, DR output 208 may specify either a positive or negative detection for more than mild DR (mtmDR). As described above, more than mild DR may be DR having a DRSS score of at least 35. In some cases, more than mild DR may be DR having a DRSS score that is at least 35 but below 90.

In some embodiments, the deep learning model of model 202 may generate metric 206 in the form of a predicted DRSS severity score for the eye of the subject based on model input 200. DR detection system 122 may then generate DR output 208 that indicates whether the predicted DRSS severity score falls within the selected range of severity (e.g., at or above 35). In this manner, DR detection system 122 may be implemented in different ways to provide an indication of whether DR of a selected severity or within a selected range of severity (e.g., more than mild DR, more than moderate DR, etc.) is present in the eye of the subject.

When the imaging data in model input 200 takes the form of color fundus imaging data (e.g., 7-field or 4-widefield color fundus images), model 202 may process the data for each eye at the image level. For example, a 7-field color fundus image may include 7 individual images. Each of these images may be sent into model 202 for processing to generate 7 intermediate metrics. These intermediate scores may be averaged together to form metric 206.

In one or more embodiments, model 202 is trained on training data 210 for a plurality of training subjects. The plurality of training subject may be subjects diagnosed with diabetes. In one or more embodiments, the prevalence of comorbid ocular conditions within the plurality of training subjects is below about 5%. For example, only 1%, 2%, or 3% of the plurality of training subjects may have been determined (e.g., via manual grading of images such as color fundus images) to have comorbid ocular conditions. Having such a small percentage with comorbid ocular conditions helps ensure that an out-of-distribution technique can be used to detect comorbid ocular conditions.

Training data 210 may include, for example, without limitation, training imaging data. The training imaging data may include imaging data similar to imaging data 110 described above. Training data 210 may also include training baseline demographic data and/or training baseline clinical data. In one or more embodiments, training data 210 may be split into a train dataset 212, a tune dataset 214, and a test dataset 216. This split may be proportioned as, for example, without limitation, 80% of the samples in training data 210 form train dataset 212, 10% of the samples form tune dataset 214, and 10% of the samples form test dataset 216. In other examples, 80% of the samples may be used for train dataset 212, 20% of the samples may be used for test dataset 216, and no samples may be used for tune dataset 214. Of course, in other embodiments, splits of other percentages may be used.

Train dataset 212 is used to fit the parameters of model 202 (e.g., the weights of the connections between neurons in model 202). Tune dataset 214 is used evaluate model fit while tuning the hyperparameters in model 202. Tune dataset 214 may be used for regularization in some cases. Tune dataset 214 may also be called a validation dataset. Test dataset 216 is used to provide an evaluation of the final model fit. In these examples, test dataset 216 is a group of samples that are not used in training and accordingly, test dataset 216 may also be called a hold or holdout dataset. Model 202 may be trained at the image level.

In one or more embodiments, DR detection system 122 may be implemented using one or more of the methods, one or more of the systems, or both described in International Publication No. WO 2022/120163 A1, which is incorporated by reference herein in its entirety.

### II.C. Comorbidity Detection System

With continuing reference to FIG. 2, data analyzer 108 also includes comorbidity detection system 124 that may receive detector input 218. Comorbidity detection system 124 may receive and process detector input 218 to generate comorbidity output 220 that indicates whether comorbid ocular conditions are detected. Comorbidity detection system 124 may be implemented in various ways, some of which are independent of DR detection system 122 and some of which are dependent on the processing performed by DR detection system 122.

In one or more embodiments, comorbidity detection system 124 takes the form of a deep learning model that is trained to classify detector input 218 as evidencing the presence of comorbid ocular conditions or not. In one or more embodiments, the deep learning model takes the form of a binary classification model. In these examples, detector input 218 may be formed by at least a portion of model input 200. The deep learning model may output a score or classification that indicates whether a presence of comorbid ocular conditions is detected or not.

In other embodiments, comorbidity detection system 124 comprises out-of-distribution (OOD) detector 222 that receives and processes detector input 218. For example, detector input 218 that is out-of-distribution (OOD) from the train dataset 212 used to train model 202 of DR detection system 122 may be considered indicative of the presence of comorbid ocular conditions. OOD detector 222 may generate comorbidity output 220 based on detector input 218 that indicates whether detector input 218 is considered OOD. OOD detector 222 may be implemented in different ways.

### II.C.1. OOD Detection via Binary Classification

In one or more embodiments, OOD detector 222 includes model 224. Model 224 may include a deep learning model. The deep learning model may include one or more neural networks. For example, the deep learning model may include a convolutional neural network system. In one or more embodiments, model 224 includes a binary classification model that is comprised of one or more convolutional neural networks.

In one or more embodiments, model 224 includes an OOD binary classification model. For example, model 224 may be trained to detect an OOD eye. An OOD eye may be one that is out-of-distribution with respect to the train dataset 212 used for the training of model 202 of DR detection system 122.

In one or more embodiments, the test dataset 216 of training data 210 may be processed via DR detection system 122. Correctly scored (or labeled) samples may be annotated as in-distribution (ID), while incorrectly scored (or labeled) samples may be annotated as OOD to form an annotated dataset 226. Model 224 may be trained on annotated dataset 226 to classify a given input as either ID or OOD. A classification of OOD indicates an above-threshold likelihood that the given input is for an eye that is afflicted with comorbid ocular conditions. Once trained, model 224 may be used to detect the presence of comorbid ocular conditions with high sensitivity and specificity.

For example, model 224 may receive detector input 218 for processing. In these embodiments, detector input 218 includes model input 200 as described above in Section II.B. For example, the same model input 200 that is sent into model 202 of DR detection system 122 may be sent independently into model 224 of comorbidity detection system 124. In other examples, detector input 218 may be formed by a portion of model input 200 that at least includes imaging data 110. As one example, while model input 200 sent into DR detection system 122 may include imaging data 110 and baseline demographic data 118, detector input 218 may be formed using only imaging data 110.

Model 224 processes detector input 218 to generate score 228. Score 228 indicates whether a presence of comorbid ocular conditions is detected in the eye of the subject. For example, score 228 may be a probability value or a value indicating a likelihood that comorbid ocular conditions are present. Score 228 may be a value between and/or including 0 and 1. In other embodiments, score 228 is a category or classifier for the probability or likelihood (e.g., a category selected from a low probability or likelihood and a high probability or likelihood, etc.).

In one or more embodiments, score 228 is a binary indication of whether the probability or likelihood is above a selected minimum threshold. In some embodiments, the minimum threshold is at least about 0.4, 0.5, 0.6, 0.7, 0.8, 0.9, or some other threshold between 0.4 and 0.95. In one or more embodiments, score 228 is a binary indication of whether the probability or likelihood is below a selected maximum threshold. In some embodiments, the maximum threshold is at most about 0.6, 0.5, 0.4, 0.3, 0.2, 0.1, or some other threshold between 0.05 and 0.7. In one or more embodiments, score 228 is a binary indication of whether the probability or likelihood is between a selected range that is defined by a first value selected from any of the preceding values described for the minimum threshold and a second value selected from any of the preceding values described for the maximum threshold.

Comorbidity detection system 124 outputs comorbidity output 220. Comorbidity output 220 may be score 228 or may be an output generated based on score 228. As one example, comorbidity output 220 may take the form of a binary output having either a first value (e.g., numerical or text) or a second value (e.g., numerical or text). The first value indicates a positive detection of comorbid ocular conditions and the second value indicates a negative detection of comorbid ocular conditions.

A detection of comorbid ocular conditions may be based on whether the likelihood that these conditions are present meets one or more criteria (e.g., is above a selected threshold, is below a selected threshold, etc.). Thus, a positive detection means that the likelihood that these comorbid ocular conditions are present meets the one or more criteria, while a negative detection means that the one or more criteria are not met.

### II.C.2. OOD Detection via Uncertainty Estimation

In one or more embodiments, out-of-distribution detector 222 uses an uncertainty estimation module 230 that determines an uncertainty associated with metric 206 generated by model 202 of DR detection system 122 based on model input 200. A greater level of uncertainty may be indicative of the presence of comorbid ocular conditions. A lower level of uncertainty may be indicative of an absence of comorbid ocular conditions.

In some cases, model 202 may use dropout (e.g., at least one dropout layer) to avoid overfitting. Each run (e.g., runtime iteration or forward pass) of the model randomly drops out various nodes or neurons such that metric 206 generated by model 202 is different for each iteration or pass. When model 202 uses dropout, uncertainty estimation module 230 may be implemented using, for example, without limitation, an uncertainty estimation algorithm such as a Monte Carlo Dropout algorithm. With the Monte Carlo Dropout algorithm, multiple runs or forward passes (e.g., 5, 8, 10, 15, 20, etc.) of model 202 may be performed with the same model input 200 to generate a plurality of metrics (e.g., in the form of probabilities or likelihoods) based on the same model input 200. In this manner, detector input 218 takes the form of model input 200 in these examples.

Uncertainty estimation module 230 generates score 228 based on the plurality of metrics. Score 228 may be, for example, a statistical metric that indicates either a positive detection or a negative detection. For example, score 228 may be the standard deviation of the plurality of metrics. A larger standard deviation may represent a greater level of uncertainty. Here, a greater level of uncertainty may be indicative of an OOD input, while a lower level of uncertainty may be indicative of an ID input. In this manner, a standard deviation above a selected threshold may be considered a positive OOD detection and thereby, a positive detection for comorbid ocular conditions.

Uncertainty estimation module 230 uses score 228 to generate comorbidity output 220. Comorbidity output 220 may include score 228 or an output that indicates whether score 228 indicates a positive or negative detection for OOD (e.g., whether score 228 is above a selected threshold). A positive detection for OOD may be considered a positive detection for the presence of comorbid ocular conditions.

In one or more embodiments, the Monte Carlo Dropout algorithm described above may be implemented using one or more of the methodologies described in Gal, Yarin, and Zoubin Ghahramani. “Dropout as a Bayesian Approximation: Representing Model Uncertainty in Deep Learning.” International Conference on Machine Learning. PMLR, 2016, which is incorporated by reference herein in its entirety.

### II.C.3. OOD Detection via Confidence Score

In one or more embodiments, out-of-distribution detector 222 uses a confidence module 232 that determines a confidence associated with metric 206 generated by model 202 of DR detection system 122 based on model input 200. A higher level of confidence in metric 206 for a given model input 200 (which may thus form detector input 218) may indicate that model input 200 is OOD (or more likely OOD). On the other hand, a lower level of confidence in metric 206 may indicate that model input is ID (or more likely ID).

As previously described in Section II.B., model 202 may include a deep learning model comprised of one or more neural networks. Confidence module 232 may use information obtained from model 202 after model input 200 has been processed through model 202 to generate score 228.

For example, confidence module 232 may generate class conditional Gaussian distributions for the feature map corresponding to an intermediate layer of the deep learning model. Confidence module 232 uses these class conditional Gaussian distributions to generate a confidence metric, based on the Mahalanobis distance. The Mahalanobis distance is the distance from a point (detector input 218) and a distribution (the class conditional Gaussian distribution). The confidence metric is computed as the distance between detector input 218 and the “closest” class conditional Gaussian distribution. The intermediate layer may be any of the layers of the deep learning model between the input layer and the output layer. In various embodiments, the intermediate layer selected is the penultimate layer of the deep learning model.

The confidence metric may be used in an unaltered form as score 228 (e.g., confidence score). In other examples, the log of the confidence metric may be used as the confidence score, score 228. Score 228, a confidence score in these examples, indicates either a positive or negative OOD detection. For example, a higher confidence score indicates that model input 200 is ID, while a lower confidence score indicates that model input 200 is OOD. In this manner, score 228 below a selected threshold may indicate a positive OOD detection, which may, in turn, be indicative of the presence of comorbid ocular conditions.

In one or more embodiments, confidence module 232 may be implemented using one or more of the methodologies described in Lee, Kimin, et al. “A Simple Unified Framework for Detecting Out-of-Distribution Samples and Adversarial Attacks.” Advances in Neural Information Processing Systems 31 (2018), which is incorporated by reference herein in its entirety.

### II.D. Exemplary Deep Learning Model Architecture

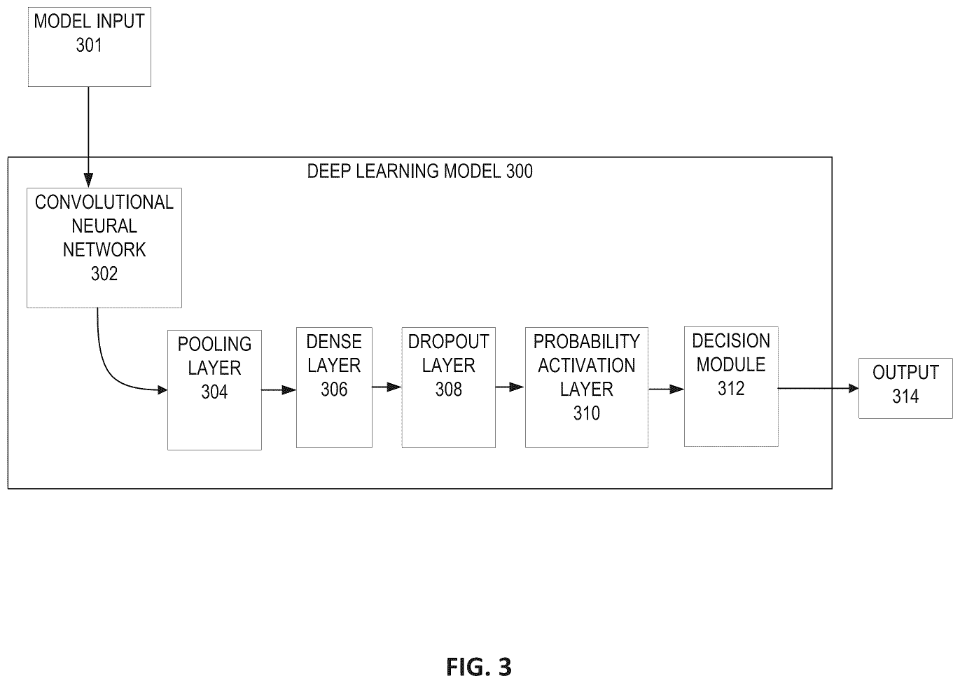

FIG. 3 is a schematic diagram of an exemplary deep learning model 300 in accordance with one or more embodiments. Deep learning model 300 may be one example of an implementation for model 202 in FIG. 2. A model that is the same as or similar to deep learning model 300 may also be used as one example of an implementation for model 224 in FIG. 2. In FIG. 3, deep learning model 300 includes a neural network system. Deep learning model 300 may be used to process model input 301, which may be one example of an implementation for model input 200 in FIG. 2. Model input 301 may include, for example, but is not limited to, 7-field color fundus imaging data.

In one or more embodiments, deep learning model 300 takes the form of a binary classification model. For example, deep learning model 300 may include one or more convolutional neural networks. In one or more embodiments, deep learning model includes convolutional neural network 302. Convolutional neural network 302 may include, for example, without limitation, a ResNet-50 model that has been pretrained using ImageNet.

Deep learning model 300 may further include various other layers and/or modules. These other layers may include, but are not limited to, at least one of a pooling layer 304, a dense layer 306, a dropout layer 308, a probability activation layer 310, and a decision module 312.

Pooling layer 304 may be an average pooling layer in some cases. Dense layer 306 may include one or more dense layers. Probability activation layer 310 may convert the vectors generated by, for example, dense layer 306 into a score probability or probability-type value. Decision module 312 may determine whether this value is above a selected threshold. An above-threshold value may be designated a positive detection, while a below-threshold value is designated a negative detection. Decision module 312 generates output 314 that indicates either a positive or negative detection. Metric 314 may be one example of an implementation for DR output 208 in FIG. 2.

### III. Exemplary Methodologies for Detecting Comorbid Ocular Conditions

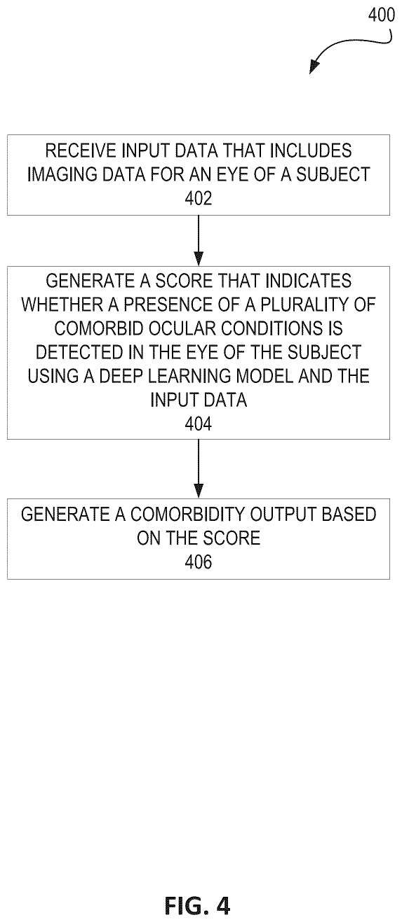

FIG. 4 is a flowchart of a process for detecting the presence of comorbid ocular conditions in accordance with one or more embodiments. In one or more embodiments, process 400 may be implemented using detection system 100 described in FIG. 1 and/or data analyzer 108 described in FIGS. 1-2. Process 400 includes various steps and may be described with continuing reference to FIGS. 1-2. One or more steps that are not expressly illustrated in FIG. 4 may be included before, after, in between, or as part of the steps of process 400. In some embodiments, process 400 may begin with step 402.

Step 402 includes receiving input data that includes imaging data for an eye of a subject. The imaging data includes eye imaging data, which may include any type of imaging data (e.g., images, stereoscopic images, etc.) that captures the eye (e.g., at least the retina) of a subject. For example, the imaging data may include CF imaging data, OCT imaging data, FA imaging data, FAF imaging data, IR imaging data, (nIR) imaging data, or a combination thereof. The input data and imaging data may be input data 109 and imaging data 110, respectively, in FIG. 1.

In one or more embodiments, the input data may further include baseline demographic data, baseline clinical data, or both. For example, baseline demographic data may include, but is not limited to, at least one of an age, sex, height, weight, race, ethnicity, or other type of demographic data associated with the subject. Baseline clinical data may include, but is not limited to, a diabetic status of the subject, such as a diabetes type (e.g., type 1 diabetes or type 2 diabetes) or diabetes duration.

Step 404 includes generating a score that indicates whether a presence of a plurality of comorbid ocular conditions is detected in the eye of the subject using a deep learning model and the input data. Examples of ocular conditions that may afflict an eye simultaneously (i.e., be considered comorbid) may include ocular diseases, ocular disorders, abnormal ocular characteristics (or features), and/or other types of conditions associated with the eye that impact vision health. Comorbid ocular conditions may include, for example, but are not limited to DR, glaucoma, drusen, ocular neuropathy, AMD, nAMD, geographic atrophy, and macular edema.

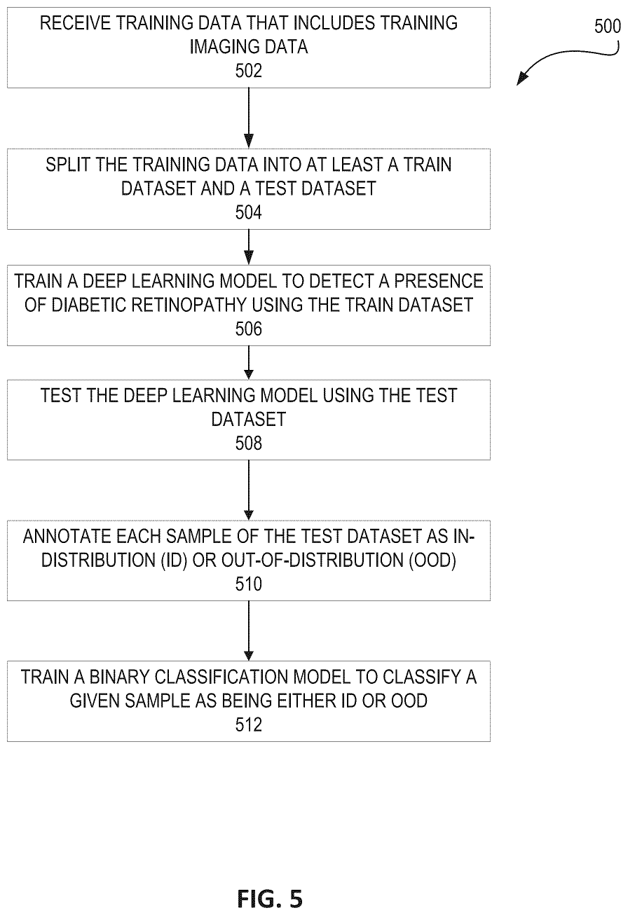

The score may be generated using, for example, DR detection system 122 in FIGS. 1-2 and comorbidity detection system 124 in FIGS. 1-2. The score may be score 228 in FIG. 2. Examples of different ways in which score may be generated are described in greater detail below in FIGS. 5-7.

Step 406 includes generating a comorbidity output based on the score. The comorbidity output, which may be comorbidity output 220 in FIG. 2, indicates whether comorbid ocular conditions have been detected (e.g., as defined by a likelihood that is greater than a selected threshold that comorbid ocular conditions are present). In some cases, both the score in step 404 and the comorbidity output in step 406 are generated by the deep learning model in step 404. In other examples, the score may be generated by the deep learning model or using information provided via use of the deep learning model in an inference mode and the comorbidity output may be generated by a decision module that determines whether the score meets a set of criteria (e.g., is above a selected threshold, is below a selected threshold, etc.) to determine whether comorbid ocular conditions are detected.

In one or more embodiments, input data for a subject that evidences the presence of comorbid ocular conditions is considered an out-of-distribution input with respect to the train dataset used to train the deep learning model used to generate the score in step 404. In these examples, the comorbidity output generated in step 406 indicates whether the input data is out-of-distribution or in-distribution to thereby indicate whether there is a positive detection or a negative detection, respectively, for the comorbid ocular conditions.

The comorbidity output may include the score and, in some cases, other information generated based on score. The comorbidity output may be a classification based on the score. For example, when the score is a probability or likelihood value, the comorbidity output may be a classification of a positive detection when the score is above a selected threshold or a negative detection when the score is below a selected threshold. In other examples, the comorbidity output may be a classification of a positive detection when the score is below a selected threshold or a negative detection when the score is above a selected threshold.

FIG. 5 is a flowchart of a process for training a binary classification model to generate a score that indicates whether comorbid ocular conditions are detected in accordance with one or more embodiments. In one or more embodiments, process 500 may be implemented using detection system 100 described in FIG. 1 and/or data analyzer 108 described in FIGS. 1-2. Process 500 includes various steps and may be described with continuing reference to FIGS. 1-2. One or more steps that are not expressly illustrated in FIG. 5 may be included before, after, in between, or as part of the steps of process 500. Process 500 may be one example of an implementation for training a deep learning model to generate a score as described in step 404 in FIG. 4.

Step 502 includes receiving training data that includes training imaging data. This training data may be, for example, training data 210 in FIG. 2. In one or more embodiments, the training data includes color fundus imaging data (e.g., 7-field or 4-widefield color fundus imaging data) for at least one each of a plurality of subjects.

Step 504 includes splitting the training data into at least a train dataset and a test dataset. The train dataset and the test dataset each include a portion of the training data. In some examples, the training data is split into a train dataset, a test dataset, and a tune dataset. In one or more embodiments, the samples in the training data may be split with, for example, without limitation, 80% for the train dataset, 10% for the tune dataset, and 10% for the test dataset. In other embodiments, the split may be 80% for the train dataset and 20% for the test dataset.

Step 506 includes training a deep learning model to detect a presence of diabetic retinopathy using the train dataset. In some examples, when the training dataset is split to also form a tune dataset, step 506 further includes tuning the deep learning using the tune dataset after training. The deep learning model may be, for example, one example of an implementation for model 202 in FIG. 2. In this manner, the deep learning model may be part of DR detection system 122 in FIG. 2.

Step 508 includes testing the deep learning model using the test dataset. The test dataset may be a holdout set that includes samples not previously seen during the training in step 506.

Step 510 includes annotating each sample (e.g., portion of input data) of the test dataset as in-distribution (ID) or out-of-distribution (OOD). In one or more embodiments, a sample (e.g., imaging data for one eye of a training subject) may be considered ID if the deep learning model correctly labeled the sample as having or not having DR. In these embodiments, a sample may be considered OOD if the deep learning model incorrectly labeled the sample as having or not having DR. Annotating a sample may include, for example, labeling the sample as being ID or OOD.

Step 512 includes training a binary classification model to classify a given sample as being either ID or OOD. In step 512, the binary classification model uses a same type of imaging data as was used in training (e.g., step 502). A classification of OOD may be considered a positive detection for comorbid ocular conditions. A classification of ID may be considered a negative detection for comorbid ocular conditions.

The binary classification model may be one example of an implementation for model 224 in FIG. 2. In this manner, the binary classification model may be part of OOD detector 222 of comorbidity detection system 124 in FIG. 2.

The process 500 described in FIG. 5 may be used to train a binary classification model to be able to generate a score (e.g., the score generated in step 404 in FIG. 4) that indicates whether given input data for an eye of a subject is ID or OOD. A decision module within the binary classification module or separate from binary classification model may be used to generate the comorbidity output (e.g., the comorbidity output generated in step 404 in FIG. 4) based on the score.

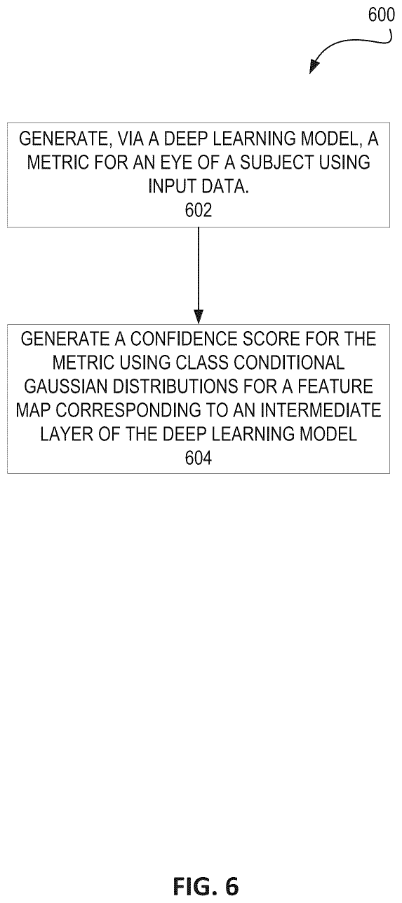

FIG. 6 is a flowchart of a process for generating a confidence score that indicates whether comorbid ocular conditions are detected in accordance with one or more embodiments. In one or more embodiments, process 600 may be implemented using detection system 100 described in FIG. 1 and/or data analyzer 108 described in FIGS. 1-2. In particular, process 600 may be implemented using model 202 in FIG. 2 and confidence module 232 in FIG. 2. Process 600 includes various steps and may be described with continuing reference to FIGS. 1-2. One or more steps that are not expressly illustrated in FIG. 6 may be included before, after, in between, or as part of the steps of process 600. Process 600 may be one example of an implementation for generating a score as described in step 404 in FIG. 4.

Step 602 includes generating, via a deep learning model, a metric for an eye of a subject using input data. The input data may be, for example, the same input data received in step 402 in FIG. 4. The metric indicates a likelihood of a presence of diabetic retinopathy in the eye of the subject. The deep learning model may be one example of an implementation for model 202 in FIG. 2.

Step 604 includes generating a confidence score for the metric using class conditional Gaussian distributions for a feature map corresponding to an intermediate layer of the deep learning model. Step 604 may be implemented using a confidence module such as confidence module 232 of OOD detector 222 in FIGS. 1-2.

In step 604, the confidence module generates class conditional Gaussian distributions for the feature map corresponding to an intermediate layer of the deep learning model. The feature map includes the values of the parameters (e.g., weights) of the intermediate layer of the deep learning model. The confidence module uses these class conditional Gaussian distributions to generate the confidence score based on the Mahalanobis distance. The confidence score is one example of an implementation for the score generated in step 404 in FIG. 4, and thereby one example of an implementation for score 228 in FIG. 2. Mahalanobis distance is the distance from a point (e.g., the input data) and a distribution (the class conditional Gaussian distribution). The confidence score is computed as the distance between the input data and the “closest” class conditional Gaussian distribution. The intermediate layer may be any of the layers of the deep learning model between the input layer and the output layer. In various embodiments, the intermediate layer selected is the penultimate layer of the deep learning model.

In some cases, the confidence score computed using the Mahalanobis distance is an intermediate score. In these cases, this intermediate score is used to compute a final confidence score which may be, for example, the log of the intermediate confidence score.

The confidence score indicates either a positive or negative OOD detection. For example, a higher confidence score indicates that input data for the subject is ID, while a lower confidence score indicates that the input data for the subject is OOD. In this manner, a confidence score below a selected threshold may indicate a positive OOD detection, which may, in turn, be indicative of the presence of comorbid ocular conditions.

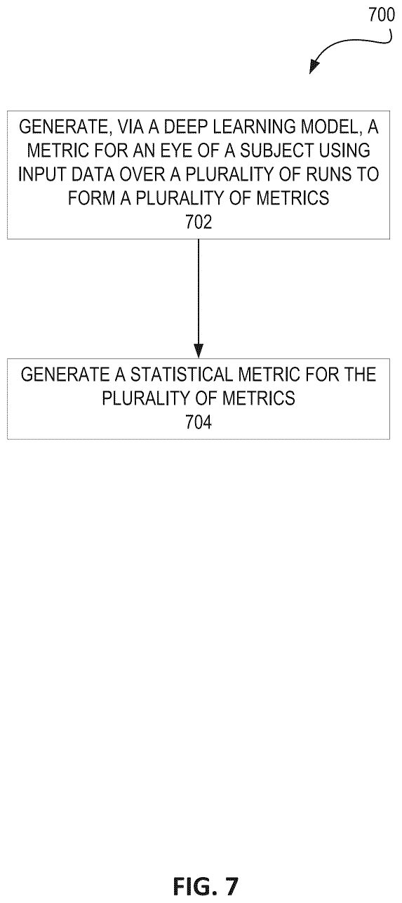

FIG. 7 is a flowchart of a process for generating a statistical metric that indicates whether comorbid ocular conditions are detected in accordance with one or more embodiments. In one or more embodiments, process 700 may be implemented using detection system 100 described in FIG. 1 and/or data analyzer 108 described in FIGS. 1-2. In particular, process 700 may be implemented using model 202 in FIG. 2 and uncertainty estimation module 230 in FIG. 2. Process 700 includes various steps and may be described with continuing reference to FIGS. 1-2. One or more steps that are not expressly illustrated in FIG. 7 may be included before, after, in between, or as part of the steps of process 700. Process 700 may be one example of an implementation for generating a score as described in step 404 in FIG. 4.

Step 702 includes generating, via a deep learning model, a metric for an eye of a subject using input data over a plurality of runs to form a plurality of metrics. The input data may be, for example, the same input data received in step 402 in FIG. 4. The deep learning model may be one example of an implementation for model 202 in FIG. 2. The metric for each of the plurality of runs indicates a likelihood of a presence of diabetic retinopathy in the eye of the subject.

Step 704 includes generating a statistical metric for the plurality of metrics. The statistical metric may be one example of an implementation for the score generated in step 404 in FIG. 4 and thereby, one example of an implementation for score 228 in FIG. 2. The statistical metric may indicate a positive detection of the presence of the plurality of comorbid ocular conditions when the statistical metric is above a selected threshold.

For example, the deep learning model in step 702 may use dropout (e.g., at least one dropout layer) to avoid overfitting. Each run (e.g., runtime iteration or forward pass) of the deep learning model randomly drops out various nodes or neurons such that metric generated by the deep learning model is different for each iteration or pass. The uncertainty estimation module may use, for example, example, without limitation, a Monte Carlo Dropout algorithm to generate the statistical metric. With the Monte Carlo Dropout algorithm, multiple runs or forward passes (e.g., 5, 8, 10, 15, 20, etc.) of the deep learning model may be performed with the same input data to generate the plurality of metrics (e.g., in the form of probabilities or likelihoods).

The uncertainty estimation module generates the statistical metric based on the plurality of metrics. The statistical metric may be, for example, the standard deviation of the plurality of metrics. A larger standard deviation may represent a greater level of uncertainty. Here, a greater level of uncertainty may be indicative of an OOD input, while a lower level of uncertainty may be indicative of an ID input. In this manner, a standard deviation above a selected threshold may be considered a positive OOD detection and thereby, a positive detection for comorbid ocular conditions.

### IV. Computer-Implemented System

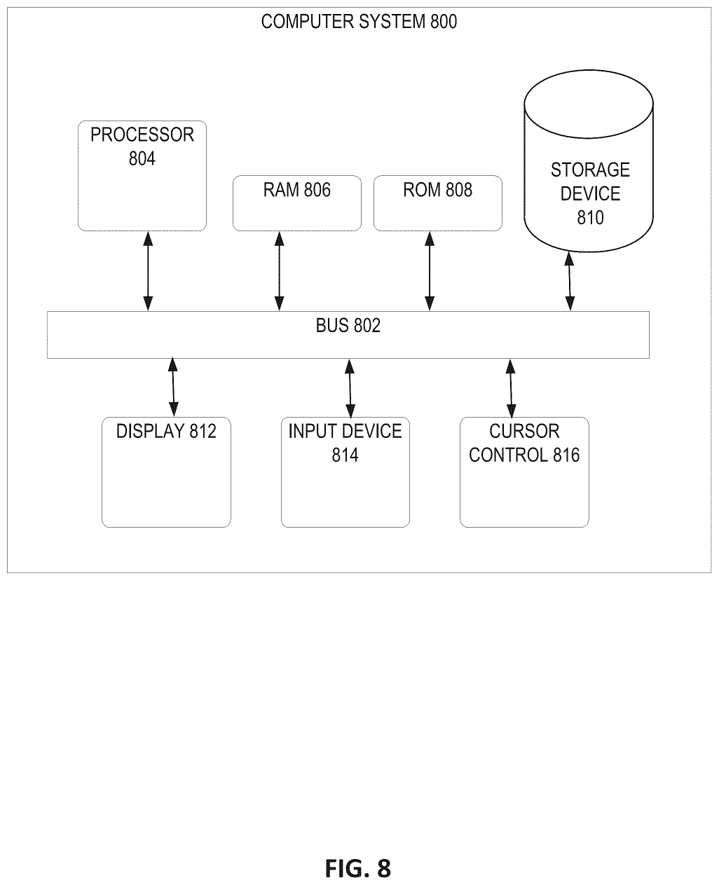

FIG. 8 is a block diagram illustrating an example of a computer system in accordance with various embodiments. Computer system 800 may be an example of one implementation for computing platform 102 described above in FIG. 1. In one or more examples, computer system 800 can include a bus 802 or other communication mechanism for communicating information, and a processor 804 coupled with bus 802 for processing information. In various embodiments, computer system 800 can also include a memory, which can be a random-access memory (RAM) 806 or other dynamic storage device, coupled to bus 802 for determining instructions to be executed by processor 804. Memory also can be used for storing temporary variables or other intermediate information during execution of instructions to be executed by processor 804. In various embodiments, computer system 800 can further include a read-only memory (ROM) 808 or other static storage device coupled to bus 802 for storing static information and instructions for processor 804. A storage device 810, such as a magnetic disk or optical disk, can be provided and coupled to bus 802 for storing information and instructions.

In various embodiments, computer system 800 can be coupled via bus 802 to a display 812, such as a cathode ray tube (CRT) or liquid crystal display (LCD), for displaying information to a computer user. An input device 814, including alphanumeric and other keys, can be coupled to bus 802 for communicating information and command selections to processor 804. Another type of user input device is a cursor control 816, such as a mouse, a joystick, a trackball, a gesture-input device, a gaze-based input device, or cursor direction keys for communicating direction information and command selections to processor 804 and for controlling cursor movement on display 812. This input device 816 typically has two degrees of freedom in two axes, a first axis (e.g., x) and a second axis (e.g., y), that allows the device to specify positions in a plane. However, it should be understood that input devices 816 allowing for three-dimensional (e.g., x, y and z) cursor movement are also contemplated herein.

Consistent with certain implementations of the present teachings, results can be provided by computer system 800 in response to processor 804 executing one or more sequences of one or more instructions contained in RAM 806. Such instructions can be read into RAM 806 from another computer-readable medium or computer-readable storage medium, such as storage device 810. Execution of the sequences of instructions contained in RAM 806 can cause processor 804 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 804 for execution. Such a medium can take many forms, including but not limited to, non-volatile media, volatile media, and transmission media. Examples of non-volatile media can include, but are not limited to, optical, solid state, magnetic disks, such as storage device 810. Examples of volatile media can include, but are not limited to, dynamic memory, such as RAM 806. Examples of transmission media can include, but are not limited to, coaxial cables, copper wire, and fiber optics, including the wires that comprise bus 802.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 804 of computer system 800 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 800 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 800, whereby processor 804 would execute the analyses and determinations provided by these engines, subject to instructions provided by any one of, or a combination of, the memory components RAM 806, ROM 808, or storage device 810 and user input provided via input device 814.

### V. Exemplary Definitions and Context

The disclosure is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion.

In addition, as the terms “on,” “attached to,” “connected to,” “coupled to,” or similar words are used herein, one element (e.g., a component, a material, a layer, a substrate, etc.) can be “on,” “attached to,” “connected to,” or “coupled to” another element regardless of whether the one element is directly on, attached to, connected to, or coupled to the other element or there are one or more intervening elements between the one element and the other element. In addition, where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

The term “subject” may refer to a subject of a clinical trial, a person undergoing treatment, a person undergoing anti-cancer therapies, a person being monitored for remission or recovery, a person undergoing a preventative health analysis (e.g., due to their medical history), or any other person or patient of interest. In various cases, “subject” and “patient” may be used interchangeably herein.

Unless otherwise defined, scientific and technical terms used in connection with the present teachings described herein shall have the meanings that are commonly understood by those of ordinary skill in the art. Further, unless otherwise indicated by context, singular terms shall include pluralities and plural terms shall include the singular. Generally, nomenclatures utilized in connection with, and techniques of, chemistry, biochemistry, molecular biology, pharmacology and toxicology are described herein are those well-known and commonly used in the art.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and, in some cases, only one of the items in the list may be used. The item may be a particular object, thing, step, operation, process, or category. In other words, “at least one of” means any combination of items or number of items may be used from the list, but not all of the items in the list may be used. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, a “model” may include one or more algorithms, one or more mathematical techniques, one or more machine learning algorithms, or a combination thereof.

As used herein, “machine learning” may be the practice of using algorithms to parse data, learn from it, and then make a determination or prediction about something in the world. Machine learning uses algorithms that can learn from data without relying on rules-based programming.

As used herein, an “artificial neural network” or “neural network” (NN) may refer to mathematical algorithms or computational models that mimic an interconnected group of artificial neurons that processes information based on a connectionistic approach to computation. Neural networks, which may also be referred to as neural nets, can employ one or more layers of linear units, nonlinear units, or both to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters. In the various embodiments, a reference to a “neural network” may be a reference to one or more neural networks.

A neural network may process information in two ways; when it is being trained it is in training mode and when it puts what it has learned into practice it is in inference (or prediction) mode. Neural networks learn through a feedback process (e.g., backpropagation) which allows the network to adjust the weight factors (modifying its behavior) of the individual nodes in the intermediate hidden layers so that the output matches the outputs of the training data. In other words, a neural network learns by being fed training data (learning examples) and eventually learns how to reach the correct output, even when it is presented with a new range or set of inputs. A neural network may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), or another type of neural network.

### VI. Recitation of Exemplary Embodiments

Embodiment 1: A method comprising: receiving input data that includes imaging data for an eye of a subject; generating a score that indicates whether a presence of a plurality of comorbid ocular conditions is detected in the eye of the subject using a deep learning model and the input data; and generating a comorbidity output based on the score identifying whether the presence of the plurality of comorbid ocular conditions is detected.

Embodiment 2: The method of embodiment 1, wherein: the deep learning model comprises a binary classification model; the score indicates a positive detection of the presence of the plurality of comorbid ocular conditions when the score is above a selected threshold; and the comorbidity output is a classification generated by the binary classification model based on the score, wherein the classification is for either a positive detection or a negative detection for the presence of the plurality of comorbid ocular conditions.

Embodiment 3: The method of embodiment 1, wherein generating the score comprises: generating, via the deep learning model, a metric for the eye of the subject using the input data, wherein the metric indicates a likelihood of a presence of diabetic retinopathy in the eye of the subject; and generating a confidence score for the metric using class conditional Gaussian distributions for a feature map corresponding to an intermediate layer of the deep learning model, wherein the confidence score indicates a positive detection of the presence of the plurality of comorbid ocular conditions when the confidence score is below a selected threshold.

Embodiment 4: The method of embodiment 3, wherein the confidence score is log of a confidence metric.

Embodiment 5: The method of embodiment 1, wherein generating the score comprises: generating, via the deep learning model, a metric for the eye of the subject using the imaging data over a plurality of runs to form a plurality of metrics, wherein the metric for each of the plurality of runs indicates a likelihood of a presence of diabetic retinopathy in the eye of the subject; and generating a statistical metric for the plurality of metrics, wherein the statistical metric indicates a positive detection of the presence of the plurality of comorbid ocular conditions when the statistical metric is above a selected threshold.

Embodiment 6: The method of embodiment 5, wherein the statistical metric is a standard deviation of the plurality of metrics.

Embodiment 7: The method of any one of embodiments 1-6, wherein the plurality of comorbid ocular conditions comprises at least two ocular conditions selected from a group consisting of glaucoma, diabetic retinopathy, drusen, ocular neuropathy, age-related macular degeneration, neovascular age-related macular degeneration, geographic atrophy, and macular edema.

Embodiment 8: The method of any one of embodiments 1-7, wherein the imaging data comprises at least one of color fundus imaging data, optical coherence tomography imaging data, fundus autofluorescence imaging data, fluorescein angiography imaging data, infrared imaging data, or near-infrared imaging data.

Embodiment 9: The method of any one of embodiments 1-8, wherein the input data further includes at least one of baseline demographic data or baseline clinical data.

Embodiment 10: The method of any one of embodiments 1-9, further comprising: generating an output based on the comorbidity output, wherein the output includes a recommendation to exclude the subject from a clinical trial when the comorbidity output indicates a positive detection for the presence of the plurality of comorbid ocular conditions.

Embodiment 11: The method of any one of embodiments 1-10, wherein the imaging data comprises at least one of either 7-field color fundus imaging data or 4-widefield color fundus imaging data.

Embodiment 12: A method comprising: receiving input data that includes imaging data for an eye of a subject; generating, via a deep learning model, a metric for the eye of the subject using the input data, wherein the metric indicates a likelihood of a presence of diabetic retinopathy in the eye of the subject; generating a confidence score for the metric in which the confidence score indicates a positive detection of a presence of a plurality of comorbid ocular conditions when the confidence score is below a selected threshold; and generating an output based on the confidence score.

Embodiment 13: The method of embodiment 12, wherein the confidence score is a log of a confidence metric generated using class conditional Gaussian distributions for a feature map corresponding to an intermediate layer of the deep learning model.

Embodiment 14: The method of embodiment 13, wherein the intermediate layer is a penultimate layer of the deep learning model.

Embodiment 15: The method of any one of embodiments 12-14, wherein the output includes a recommendation to exclude the subject from a clinical trial when the confidence score indicates the positive detection for the presence of the plurality of comorbid ocular conditions.

Embodiment 16: The method of any one of embodiments 12-15, wherein the imaging data comprises at least one of color fundus imaging data, optical coherence tomography imaging data, fundus autofluorescence imaging data, fluorescein angiography imaging data, infrared imaging data, or near-infrared imaging data.

Embodiment 17: A method comprising: receiving input data that includes imaging data for an eye of a subject; generating, via a deep learning model, a metric for the eye of the subject using the input data over a plurality of runs to form a plurality of metrics, wherein the metric for each of the plurality of runs indicates a likelihood of a presence of diabetic retinopathy in the eye of the subject; generating a statistical metric for the plurality of metrics in which the statistical metric indicates a positive detection of a presence of a plurality of comorbid ocular conditions when the statistical metric is above a selected threshold; and generating an output based on the statistical metric.

Embodiment 18: The method of embodiment 17, wherein the statistical metric is a standard deviation for the plurality of metrics generated using an uncertainty estimation algorithm.

Embodiment 19: The method of embodiment 17 or embodiment 18, wherein the output includes a recommendation to exclude the subject from a clinical trial when the statistical metric indicates the positive detection for the presence of the plurality of comorbid ocular conditions.

Embodiment 20: The method of any one of embodiments 17-19, wherein the imaging data comprises at least one of color fundus imaging data, optical coherence tomography imaging data, fundus autofluorescence imaging data, fluorescein angiography imaging data, infrared imaging data, or near-infrared imaging data.

Embodiment 21: A system for detecting comorbid ocular conditions, the system comprising: a memory containing machine readable medium comprising machine executable code; and a processor coupled to the memory, the processor configured to execute the machine executable code to cause the processor to: receive input data that includes imaging data for an eye of a subject; generate a score that indicates whether a presence of a plurality of comorbid ocular conditions is detected in the eye of the subject using a deep learning model and the input data; and generate a comorbidity output based on the score.

Embodiment 22: The system of embodiment 21, wherein: the deep learning model comprises a binary classification model; the score indicates a positive detection of the presence of the plurality of comorbid ocular conditions when the score is above a selected threshold; and the comorbidity output is a classification generated by the binary classification model based on the score, wherein the classification is for either a positive detection or a negative detection for the presence of the plurality of comorbid ocular conditions.

Embodiment 23: The system of embodiment 21, wherein the processor is further configured to execute the machine executable code to cause the processor to generated the score by: generating, via the deep learning model, a metric for the eye of the subject using the input data, wherein the metric indicates a likelihood of a presence of diabetic retinopathy in the eye of the subject; and generating a confidence score for the metric using class conditional Gaussian distributions for a feature map corresponding to an intermediate layer of the deep learning model, wherein the confidence score indicates a positive detection of the presence of the plurality of comorbid ocular conditions when the confidence score is below a selected threshold.

Embodiment 24: The system of embodiment 23, wherein the confidence score is log of a confidence metric.

Embodiment 25: The system of embodiment 21, wherein the processor is further configured to execute the machine executable code to cause the processor to generated the score by: generating, via the deep learning model, a metric for the eye of the subject using the imaging data over a plurality of runs to form a plurality of metrics, wherein the metric for each of the plurality of runs indicates a likelihood of a presence of diabetic retinopathy in the eye of the subject; and generating a statistical metric for the plurality of metrics, wherein the statistical metric indicates a positive detection of the presence of the plurality of comorbid ocular conditions when the statistical metric is above a selected threshold.

Embodiment 26: The system of embodiment 25, wherein the statistical metric is a standard deviation of the plurality of metrics.

Embodiment 27: The system of any one of embodiments 21-26, wherein the plurality of comorbid ocular conditions comprises at least two ocular conditions selected from a group consisting of glaucoma, diabetic retinopathy, drusen, ocular neuropathy, age-related macular degeneration, neovascular age-related macular degeneration, geographic atrophy, and macular edema.

Embodiment 28: The system of any one of embodiments 21-27, wherein the imaging data comprises at least one of color fundus imaging data, optical coherence tomography imaging data, fundus autofluorescence imaging data, fluorescein angiography imaging data, infrared imaging data, or near-infrared imaging data.

Embodiment 29: The system of any one of embodiments 21-28, wherein the input data further includes at least one of baseline demographic data or baseline clinical data.

### VII. Additional Considerations

The headers and subheaders between sections and subsections of this document are included solely for the purpose of improving readability and do not imply that features cannot be combined across sections and subsection. Accordingly, sections and subsections do not describe separate embodiments.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements (e.g., elements in block or schematic diagrams, elements in flow diagrams, etc.) without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

What is claimed is:

1. A method comprising:
receiving input data that includes imaging data for an eye of a subject;
generating a score that indicates whether a presence of a plurality of comorbid ocular conditions is detected in the eye of the subject using a deep learning model and the input data; and
generating a comorbidity output based on the score identifying whether the presence of the plurality of comorbid ocular conditions is detected.

2. The method of claim 1, wherein:
the deep learning model comprises a binary classification model;
the score indicates a positive detection of the presence of the plurality of comorbid ocular conditions when the score is above a selected threshold; and
the comorbidity output is a classification generated by the binary classification model based on the score, wherein the classification is for either a positive detection or a negative detection for the presence of the plurality of comorbid ocular conditions.

3. The method of claim 1, wherein generating the score comprises:
generating, via the deep learning model, a metric for the eye of the subject using the input data,
wherein the metric indicates a likelihood of a presence of diabetic retinopathy in the eye of the subject; and
generating a confidence score for the metric using class conditional Gaussian distributions for a feature map corresponding to an intermediate layer of the deep learning model,
wherein the confidence score indicates a positive detection of the presence of the plurality of comorbid ocular conditions when the confidence score is below a selected threshold.

4. The method of claim 3, wherein the confidence score is log of a confidence metric.

5. The method of claim 1, wherein generating the score comprises:
generating, via the deep learning model, a metric for the eye of the subject using the imaging data over a plurality of runs to form a plurality of metrics,
wherein the metric for each of the plurality of runs indicates a likelihood of a presence of diabetic retinopathy in the eye of the subject; and
generating a statistical metric for the plurality of metrics,
wherein the statistical metric indicates a positive detection of the presence of the plurality of comorbid ocular conditions when the statistical metric is above a selected threshold.

6. The method of claim 5, wherein the statistical metric is a standard deviation of the plurality of metrics.

7. The method of any one of claims 1-6, wherein the plurality of comorbid ocular conditions comprises at least two ocular conditions selected from a group consisting of glaucoma, diabetic retinopathy, drusen, ocular neuropathy, age-related macular degeneration, neovascular age-related macular degeneration, geographic atrophy, and macular edema.

8. The method of any one of claims 1-7, wherein the imaging data comprises at least one of color fundus imaging data, optical coherence tomography imaging data, fundus autofluorescence imaging data, fluorescein angiography imaging data, infrared imaging data, or near-infrared imaging data.

9. The method of any one of claims 1-8, wherein the input data further includes at least one of baseline demographic data or baseline clinical data.

10. The method of any one of claims 1-9, further comprising:
generating an output based on the comorbidity output, wherein the output includes a recommendation to exclude the subject from a clinical trial when the comorbidity output indicates a positive detection for the presence of the plurality of comorbid ocular conditions.

11. The method of any one of claims 1-10, wherein the imaging data comprises at least one of either 7-field color fundus imaging data or 4-widefield color fundus imaging data.

12. A method comprising:
receiving input data that includes imaging data for an eye of a subject;
generating, via a deep learning model, a metric for the eye of the subject using the input data,
wherein the metric indicates a likelihood of a presence of diabetic retinopathy in the eye of the subject;
generating a confidence score for the metric in which the confidence score indicates a positive detection of a presence of a plurality of comorbid ocular conditions when the confidence score is below a selected threshold; and
generating an output based on the confidence score.

13. The method of claim 12, wherein the confidence score is a log of a confidence metric generated using class conditional Gaussian distributions for a feature map corresponding to an intermediate layer of the deep learning model.

14. The method of claim 13, wherein the intermediate layer is a penultimate layer of the deep learning model.

15. The method of any one of claims 12-14, wherein the output includes a recommendation to exclude the subject from a clinical trial when the confidence score indicates the positive detection for the presence of the plurality of comorbid ocular conditions.

16. The method of any one of claims 12-15, wherein the imaging data comprises at least one of color fundus imaging data, optical coherence tomography imaging data, fundus autofluorescence imaging data, fluorescein angiography imaging data, infrared imaging data, or near-infrared imaging data.

17. A method comprising:
receiving input data that includes imaging data for an eye of a subject;
generating, via a deep learning model, a metric for the eye of the subject using the input data over a plurality of runs to form a plurality of metrics,
wherein the metric for each of the plurality of runs indicates a likelihood of a presence of diabetic retinopathy in the eye of the subject;
generating a statistical metric for the plurality of metrics in which the statistical metric indicates a positive detection of a presence of a plurality of comorbid ocular conditions when the statistical metric is above a selected threshold; and
generating an output based on the statistical metric.

18. The method of claim 17, wherein the statistical metric is a standard deviation for the plurality of metrics generated using an uncertainty estimation algorithm.

19. The method of claim 17 or claim 18, wherein the output includes a recommendation to exclude the subject from a clinical trial when the statistical metric indicates the positive detection for the presence of the plurality of comorbid ocular conditions.

20. The method of any one of claims 17-19, wherein the imaging data comprises at least one of color fundus imaging data, optical coherence tomography imaging data, fundus autofluorescence imaging data, fluorescein angiography imaging data, infrared imaging data, or near-infrared imaging data.

21. A system for detecting comorbid ocular conditions, the system comprising:
a memory containing machine readable medium comprising machine executable code; and
a processor coupled to the memory, the processor configured to execute the machine executable code to cause the processor to:
receive input data that includes imaging data for an eye of a subject;
generate a score that indicates whether a presence of a plurality of comorbid ocular conditions is detected in the eye of the subject using a deep learning model and the input data; and
generate a comorbidity output based on the score.

22. The system of claim 21, wherein:
the deep learning model comprises a binary classification model;
the score indicates a positive detection of the presence of the plurality of comorbid ocular conditions when the score is above a selected threshold; and
the comorbidity output is a classification generated by the binary classification model based on the score, wherein the classification is for either a positive detection or a negative detection for the presence of the plurality of comorbid ocular conditions.

23. The system of claim 21, wherein the processor is further configured to execute the machine executable code to cause the processor to generated the score by:
generating, via the deep learning model, a metric for the eye of the subject using the input data,
wherein the metric indicates a likelihood of a presence of diabetic retinopathy in the eye of the subject; and
generating a confidence score for the metric using class conditional Gaussian distributions for a feature map corresponding to an intermediate layer of the deep learning model,
wherein the confidence score indicates a positive detection of the presence of the plurality of comorbid ocular conditions when the confidence score is below a selected threshold.

24. The system of claim 23, wherein the confidence score is log of a confidence metric.

25. The system of claim 21, wherein the processor is further configured to execute the machine executable code to cause the processor to generated the score by:
generating, via the deep learning model, a metric for the eye of the subject using the imaging data over a plurality of runs to form a plurality of metrics,
wherein the metric for each of the plurality of runs indicates a likelihood of a presence of diabetic retinopathy in the eye of the subject; and
generating a statistical metric for the plurality of metrics,
wherein the statistical metric indicates a positive detection of the presence of the plurality of comorbid ocular conditions when the statistical metric is above a selected threshold.

26. The system of claim 25, wherein the statistical metric is a standard deviation of the plurality of metrics.

27. The system of any one of claims 21-26, wherein the plurality of comorbid ocular conditions comprises at least two ocular conditions selected from a group consisting of glaucoma, diabetic retinopathy, drusen, ocular neuropathy, age-related macular degeneration, neovascular age-related macular degeneration, geographic atrophy, and macular edema.

28. The system of any one of claims 21-27, wherein the imaging data comprises at least one of color fundus imaging data, optical coherence tomography imaging data, fundus autofluorescence imaging data, fluorescein angiography imaging data, infrared imaging data, or near-infrared imaging data.

29. The system of any one of claims 21-28, wherein the input data further includes at least one of baseline demographic data or baseline clinical data.
